(19) United States
(12) Patent Application Publication
(10) Pub. No.: US 2002/0157768 A1
(43) Pub. Date: Oct. 31, 2002

(54) Composite panel and bending processing method of the same

(76) Inventors: Norihisa Okada, Hikari (JP); Wataru Kawamura, Kudamatsu (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/805,055

(22) Filed: Mar. 14, 2001

(30) Foreign Application Priority Data
Mar. 16, 2000 (JP) 2000-079276

(51) Int. Cl. B31F 1/00

(52) U.S. Cl. 156/207; 156/211

(57) ABSTRACT

A composite panel of an element member in which a non-adhesion portion is mounted on a stationary table and a bending table and fixed by vacuum adsorption pads. An upper portion bending table is mounted on a face sheet of the non-adhesion portion. The face sheet is adsorbed according to the vacuum adsorption pad on the bending table. The bending table is rotated, then the face sheet is bent. A center core member is cut with a V shape. An adhesion agent is coated. Next, by rotating the bending table a face sheet is bent and the center core member is adhered to the face sheet. Without causes of a gap between a face sheet and a center core member and a partial contact, an integral bending processing of a flat sheet shape composite panel can be realized. In addition to this, in a strength assurance in a bending processing portion of the composite panel, it is unnecessary to provide a separate member and the like.

### BACKGROUND OF THE INVENTION

1. Technical Field

The present invention relates to a composite panel and a bending processing method of a composite panel.

2. Prior Art

In the prior art, in a composite panel and a bending processing method of a composite panel, two face sheets and a center core member are positioned along to the above two face sheets. Next, using a monopoly type die having a pair of a convex type and a concave type and a pressing device the two face sheets and the center core member are adhered and fixed. Or, for example, covering a monopoly die having a convex type die, the two face sheets and the center core member using a non-ventilation characteristic sheet, and by evacuating an inner portion of the sheet, the two face sheets and the center core member are adhered and fixed.

In another bending processing method of a composite panel, as shown in Japanese application utility model publication No. Hei 2-8567, from a side of a face sheet for forming an inner periphery after a bending portion of the composite panel, the face sheet which forms a side of an outer periphery after the bending portion of the composite panel is left, a V shape groove is processed, along to an apex of this groove the face sheet in the outer periphery side of the composite panel is carried out the bending processing.

In the above stated prior art techniques relating to the bending processing method of the composite panel, separating the center core member the face sheet is transformed in a predetermined bending shape, and by combining the face sheet with the center core member, since the face sheet and the center core member are adhered and fixed, it is relied on a hand working using a general purpose machine.

Further, the face sheet and the center core member which are transformed individually using the monopoly type die having the convex type and the concave type (a monopoly type having an upper portion monopoly die and a lower portion monopoly die) and the pressing device, or for example the concave type monopoly die (the lower monopoly die), the face sheet and the center core member are covered by the non-ventilation characteristic sheet member and the inner portion of the sheet member and the face sheet and the center core member are adhered and fixed.

A mutual gap and a partial contact (a local application of pressure) between the center core member, the face sheet and the monopoly die generate, an adhesion failure and a buckling in a thickness direction of the center core member generate and then a strength of the face sheet becomes lower. Further, in the face sheet in which the partial contact (the local application of pressure) generates a recess portion and a damage and the like, as a result an outer appearance of the face sheet is damaged.

### SUMMARY OF THE INVENTION

An object of the present invention is provide to realize a composite panel and a bending processing method of a composite panel without an occurrence of the gap or the partial contact (the local application of pressure) between the face sheet and the center core member and to provide to realize a bending composite panel having a high strength.

Another object of the present invention to provide a composite panel and a bending processing method of a composite panel wherein without the monopoly die for use in every bending configuration each a composite panel and a bending processing of a composite panel can be realized and to provide a bending composite panel having a high strength.

The above stated objects of the present invention can be attained by a composite panel comprising a first flat face sheet, a second flat face sheet, a flat center core member joined to the first flat face sheet and the second flat face sheet, characterized in that an end portion of the second flat face sheet is positioned shorter than end portion of the first flat face sheet, and the center core member in a side of the end portion of the first flat face sheet is not joined to the first flat face sheet.

The above stated objects of the present invention can be attained by a bending processing method of a composite panel having the steps forming a first flat face sheet, a second flat face sheet, and a flat center core member joined the first flat face sheet and the second flat face sheet, preparing a composite panel which is not joined to the flat center core member in a side of an end portion of the first face sheet, installing the first flat face sheet to a stationary table and a first bending table to direct to the stationary table and the first bending table, contacting a first bending table to the non-joined region of the second flat face sheet from an outer portion of the composite panel, in a condition in which the stationary table is fixed to the composite panel and the second bending table is fixed to the non-joined region of the second flat face sheet, rotating the second bending table in a direction to separate from the center core member, removing the flat center core member in a position in which the composite panel is bent with a V shape, coating an adhesion agent to one of the second flat face sheet and an opposed face to the flat center core member, and to adhere the flat center core member to the second flat face sheet, rotating the first bending table.

The composite panel in the present invention can be applied to a polystyrene foam panel and a soldering honeycomb panel. The material of the face sheet can be employed the metal such as aluminum, a FRP (Fiber Reinforced Plastic) and the paper, etc. The material of the center core member can be employed a honeycomb shape paper, a honeycomb shape FRP (Fiber Reinforced Plastic), and a foam material such as vinyl chloride, phenylic acid (phenol), acrylic acylate, urethane. The joining manner of the center core member with the face sheet can be employed the soldering manner, the adhesion manner, and the welding manner, etc.

### BRIEF DESCRIPTION OF DRAWING

FIG. 1 is a longitudinal cross-sectional view showing an initial state of an essential portion of a bending processing device having a composite panel of one embodiment according to the present invention;

FIG. 2 is a longitudinal cross-sectional view showing a midway of a bending processing in the bending processing device of FIG. 1;

FIG. 3 is a longitudinal cross-sectional view showing a state in which the bending processing is proceeded from FIG. 2 in the bending-processing device of FIG. 1;

FIG. 4 is the longitudinal cross-sectional view showing a state in which a bending processing is proceeded from FIG. 3 in the bending processing device of FIG. 1;

FIG. 5 is a longitudinal cross-sectional view showing a state in which the bending processing is proceeded from FIG. 4 in the bending processing device of FIG. 1;

FIG. 6 is a whole perspective view showing the bending processing device of FIG. 1;

FIG. 7 is a front view showing an end portion of a bending table of the bending processing device of FIG. 1; and

FIG. 8 is a longitudinal cross-sectional view of the end portion of a bending table of the bending processing device of FIG. 7.

### DESCRIPTION OF THE INVENTION

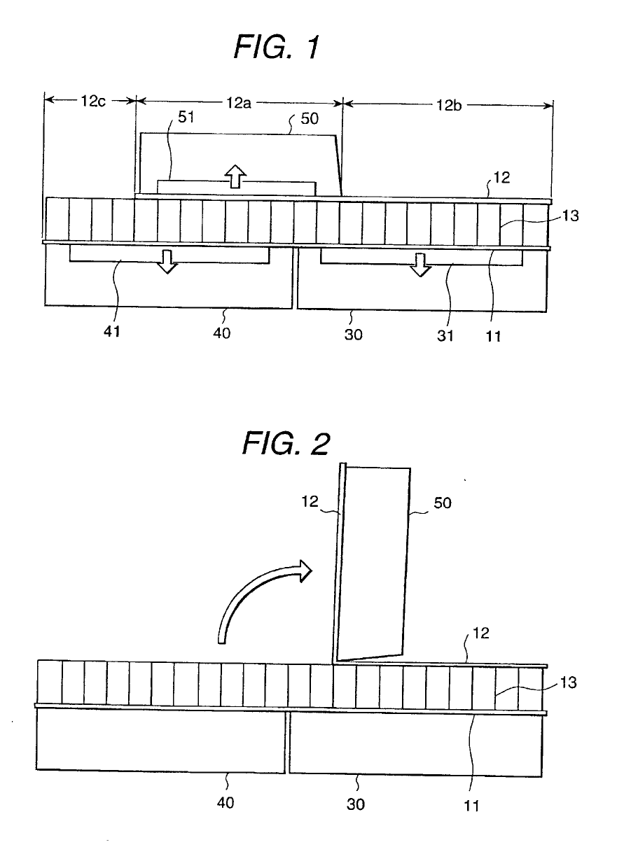

A composite panel and a bending processing of a composite panel of one embodiment according to the present invention will be explained referring to from FIG. 1 to FIG. 5. Firstly, a construction of an element material of a composite panel for carrying out a bending processing will be explained. In FIG. 1, the composite panel to be subjected to the bending processing comprises a face sheet 11 which becomes a side of an outer face in an use time, a face sheet 12 which becomes a side of an inner face in the use time, and a center core member 13 which is arranged between the face sheet 11 and the face sheet 12. These three members (the face sheet 11, the face sheet 12, and the center core member 13) are constituted as one body according to an adhesion manner.

Each of the face sheet 11 and the face sheet 12 is formed by a metal sheet such as an aluminum sheet, a steel sheet and the like and further each of the face sheet 11 and the face sheet 12 is formed by the above stated metal sheet and a vinyl chloride adhesion dressing sheet or a melanin resin dressing sheet etc. being put to adhere together by a coating, and a thickness of the face sheet 11 or the face sheet 12 is about 0.5 mm-2.0 mm.

The center core member 13 is formed by a paper center core member such as a roll core and a paper honeycomb and further the center core member 13 is formed by a urethane-foam resin which is filled up in a cell of the above stated paper center core member to aim a heat insulation and a sound shielding and a resilient urethane-foam resin etc. and a thickness the center core member 13 is about 20 mm-50 mm.

All faces of the face sheet 11 and the center core member 13 are adhered substantially to the face sheet 11. The meaning of the all faces will be made clearly according to the explanation of the adhesion of the face sheet 12 and the center core member 13. The face sheet 12 and the center core member 13 are adhered only at an adhesion portion 12b but are not adhered at a remaining non-adhesion portion 12a. The non-adhesion portion 12a can be obtained by avoiding a coating of an adhesion agent. The non-adhesion portion 12a is a side in which a bending processing is carried out.

A length of the face sheet 12 is shorter than a length of the face sheet 11 with a length 12c. The face sheet 12 is bent to form an inner side of the bending. Accordingly, when the bending processing of the composite panel is carried out, between the face sheet 11 and the face sheet 12 a peripheral length difference 12c generates. The inner side face sheet 12 is shorter than the face sheet 11 with a peripheral length difference 12c.

Next, the bending processing method of the composite panel will be explained. FIG. 1 shows a state in which the above stated composite panel is set on a bending processing device. Firstly, the composite panel is laid on a stationary table 30 and a bending table 40 of the bending processing device. The faces of the stationary table 30 and the bending table 40 are positioned in the horizontal same face. Forming the face sheet 12 in an upper face, the composite panel is laid on the stationary table 30 and the bending table 40. A side of the non-adhesion portion 12a to which the bending processing is carried out is laid on the bending table 40.

Next, according to vacuum pads 31 and 41 of a vacuum adsorption device which is installed on the stationary table 30 and the bending table 40, the face sheet 11 is adsorbed and fixed. Next, a bending table 50 is descended and is laid on the face sheet 12 of the non-adhesion portion 12a.

Next, according to a vacuum pad 51 of the vacuum adsorption device which is installed on the bending table 50 the face sheet 12 is adsorbed and fixed. The vacuum adsorption pads 31, 41, and 51 are installed with a predetermined interval along to the longitudinal direction (an axial direction of a center of the bending) of the stationary table 30 and the bending table 40, and the bending table 50.

Next, as shown in FIG. 2, by rotating the bending table 50 in an upper portion the face sheet 12 of the non-adhesion portion 12a is bent in the upper portion. In this embodiment according to the present invention, since the face sheet 12 is bent rectangular, a contact face of the bending table 50 is in perpendicular. The bending table 50 is positioned only at the non-adsorption portion 12a. An end portion of the bending table 50 is positioned in a boundary of the non-adhesion portion 12a and the adhesion portion 12b or in a side of the non-adhesion portion 12a a little from the boundary. The position of the end portion of the bending table 50 becomes a center of the bending. An end portion of the boundary side of the bending table 50 is inclined (is abstracted) to not contact to the face sheet 12, during the bending table 50 is rotated.

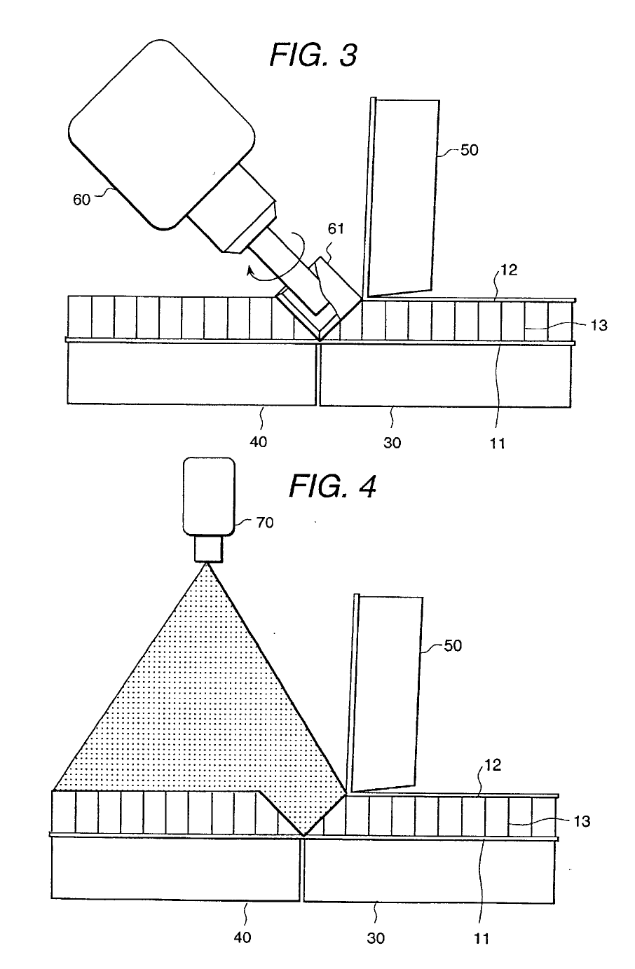

Next, as shown in FIG. 3, the center core member 13 is cut off with a V shape according to a V cutting device 60. The V cutting is carried out to remove only the center core member 13 by leaving the face sheet 11. The position of the V cutting is the bending position. An angle of the V cutting is the bending angle and is a right angle and 90 degrees. Using a knife 61 for carrying out the V cutting, two faces are cut off at the same time. In the V cutting, under a condition in which the knife 61 such as a router and an end milling 61 is inclined in a predetermined angle, and the knife 61 is sent toward a bending line direction and the center core member 13 is removed. Since the center core member 13 is formed by the paper center core member and the member in which a urethane-foam resin is filled up to the paper center core member, even-the center core member 13 is left a little in the face sheet side, by carrying out the bending processing, the center core member 13 can be crushed.

Next, as shown in FIG. 4, from the upper portion to the non-adhesion portion 12a and the V cutting portion of the center core member 13, according to an adhesion agent coating device 70, the adhesion agent is coated. In this time, since the gap between the face sheet 12 and the center core member 13 becomes large and then the adhesion agent coating can be carried out easily.

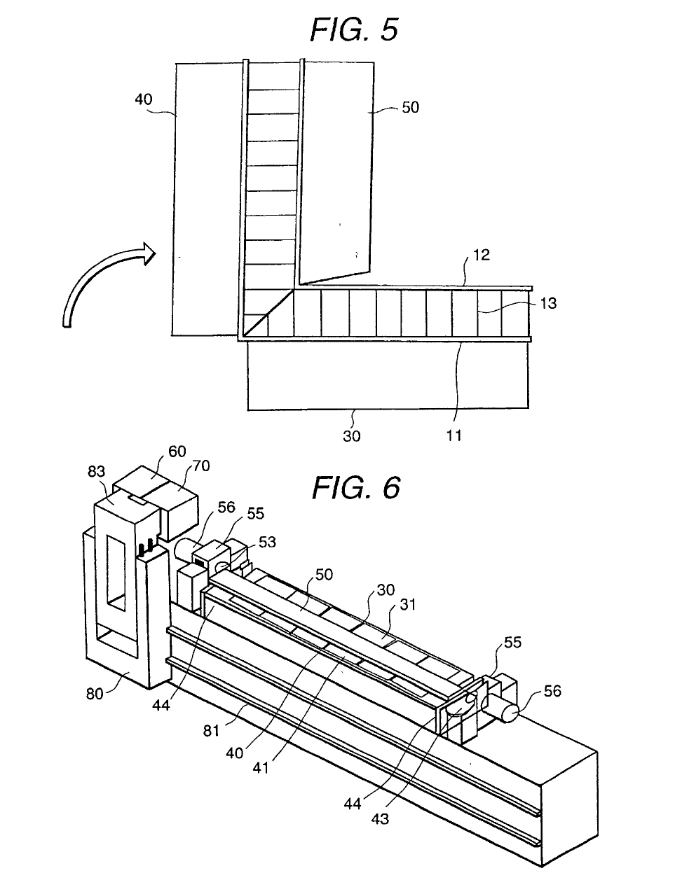

Next, as shown in FIG. 5, forming an apex of the V cutting as a center, the bending table 40 is rotated toward the upper portion, the face of the bending table 40 is formed perpendicularly. According to this, the face in which the adhesion agent has coated can be contacted to a rear face of the face sheet 12. Further, the inclined faces of the center core member 13 of the V cutting are contacted together with. Leaving this condition, the center core member 13 is maintained during the adhesion agent is hardening completed.

Next, after the vacuum of the adsorption pad 51 of the bending table 50 has released, the bending table 50 is ascended. Next, after the vacuum of the adsorption pad 41 of the bending table 40 is released, the bending table 40 is reversed to the initial time condition. Next, the composite panel which has carried out the bending processing is taken out in a side of the bending table 40 and the bending processing of the composite panel is completed.

According to the above bending processing method of the composite panel, without the occurrences of the gap and the partial contact (the local application of pressure) between the face sheet 11 and the face sheet 12 and the center core member 13, the bending processing of the composite panel can be carried out. Further, in the bending portion, since the face sheet 12 is not separated two portions, after the bending processing of the composite panel, it is unnecessary to weld the non-adhesion portion 12a and the adhesion portion 12b using the another (separation) member.

In FIG. 6, the V cutting device 60 and the coating device 70 of the adhesion agent are installed to a moving body 80. The moving body 80 moves along to a longitudinal direction of the composite panel. The moving body 80 moves along to a rail 81 of a side face of the bending processing device. The V cutting device 60 and the adhesion agent coating device 70 are installed to an ascending and descending device 83. By selecting one of the V cutting device 60 and the adhesion agent coating device 70, it is possible to use the practical use.

Both ends of the bending table 50 are installed rotatably freely on an ascending and descending device 55 through a shaft 53. The ascending and descending device 55 is ascended and descended vertically according to the rail 81. A reference numeral 56 is a drive machine for rotation use.

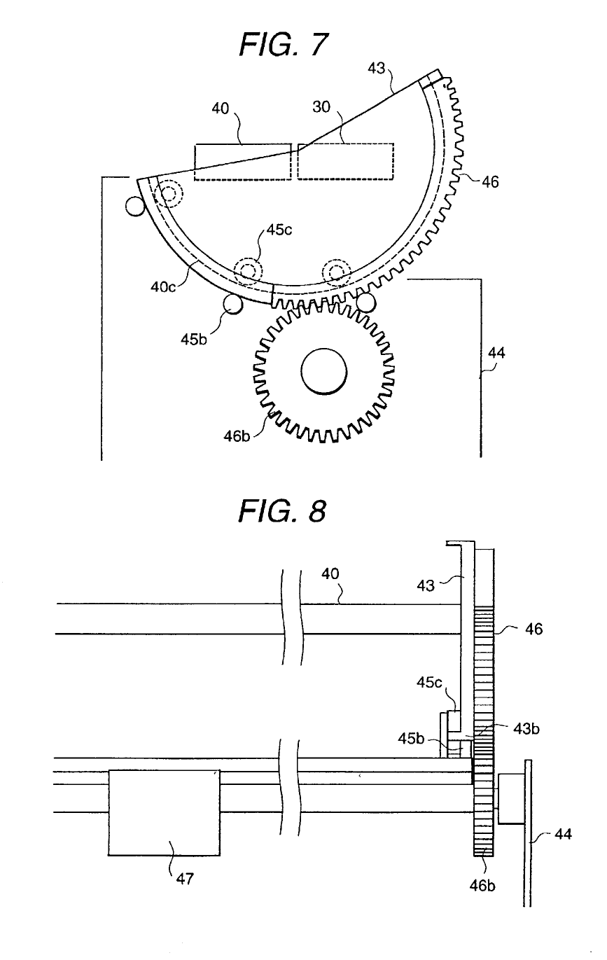

A rotation device of the bending table 40 will be. explained referring to FIG. 7 and FIG. 8. To the both ends of the bending table 40 a semi-circular flange 43 is installed. This flange 43 is supported by plural rollers 45b and 45c which are installed to a frame stand 44. The plural rollers 45b and 45c are installed in a circular arc shape. The roller 45b supports a lower face of the flange 43. The roller 45c contacts to an upper face of a circular arc shape guide rail 43b which is installed on the flange 43. Further, to the lower face of the bending table 40 the circular arc shape projection portions are provided with a predetermined interval and are supported by the frame stand 44.

To a left portion and a right portion of the flange 43 gears 46 are installed. The gear 46 has a rotation angle part of the bending table 40. To the frame stand 44, the pinion gears 46b for meshing with the gears 46 are provided. To pinion gears 46b at the both sides are rotated according to a single motor 47.

In the above stated embodiment according to the present invention, the bending angle is 90 degrees but in a case of another angle suiting to this angle the V cutting is carried out. For example, an end milling having the same of a bending angle to an angle forming an axial end and a side face of the end milling is used. Further, even when the angle of the V cutting is smaller than the bending angle, the center core member 13 is crushed in general, the bending processing of the composite panel can be carried out.

The adhesion agent can be coated to the face sheet 12 of the side of the center core member 13. However, when the adhesion agent is coated to the V cutting portion, a high strength can be obtained, it is preferable to carry out the coating to the center core member 13.

A technical range according to the present invention is not limited by the wordings defined in each claim of what is claimed is or the wordings stated on the means for solving the problems and further it refers also to the range in which the man belonged in this technical field can be placed easily.

According to the present invention, one face sheet to which a part thereof is not adhered is bent, the center core member is removed, next the adhesion agent is coated, next another face sheet is folded and adhered, the gap between the face sheet and the center core member and the partial contact (the local application of pressure) are not caused, it is possible to carry out the bending processing of the composite panel. Since the cutting of the face sheet is unnecessary but the face sheet continues, the strength assurance in the bending processing portion can be obtained.

What is claimed is:

1. A composite panel comprising:
a first flat face sheet, a second flat face sheet, a flat center core member joined to said first flat face sheet and said second flat face sheet, characterized in that
an end portion of said second flat face sheet is positioned shorter than end portion of said first flat face sheet; and
said center core member in a side of said end portion of said first flat face sheet is not joined to said first flat face sheet.

2. A composite panel according to claim 1, characterized in that
said end portion of said second flat face sheet is positioned shorter than end portion of said flat center core member.

3. A composite panel comprising:
a first flat face sheet, a second flat face sheet, a flat center core member joined to said first face sheet and said second flat face sheet, characterized in that
said first flat face sheet, said second flat face sheet, and said flat center core member are bent in a midway; and
each of said first flat face sheet and said second flat face sheet is respectively one sheet.

4. A bending processing method of a composite panel having the steps:
forming a first flat face sheet, a second flat face sheet, and a flat center core member joined said first flat face sheet and said second flat face sheet;
preparing a composite panel which is not joined to said flat center core member in a side of an end portion of said first face sheet;
installing said first flat face sheet to a stationary table and a first bending table to direct to said stationary table and said first bending table;
contacting a first bending table to said non-joined region of said second flat face sheet from an outer portion of said composite panel;
in a condition in which said stationary table is fixed to said composite panel and said second bending table is fixed to said non-joined region of said second flat face sheet, rotating said second bending table in a direction to separate from said center core member;
removing said flat center core member in a position in which said composite panel is bent with a V shape;
coating an adhesion agent to one of said second flat face sheet and an opposed face to said flat center core member; and
to adhere said flat center core member to said second flat face sheet, rotating said first bending table.

5. A bending processing method of a composite panel according to claim 4, characterized by
carrying out a fixing between said stationary table and said composite panel according to a vacuum adsorption pad; and
carrying out a fixing between said second bending table and said second flat face sheet according to a vacuum adsorption pad which is installed to said second bending table.

6. A bending processing method of a composite panel according to claim 4, characterized by
coating a coat of said adhesion agent to said flat center core member.

7. A bending processing method of a composite panel according to claim 6, characterized by
coating said coat of said adhesion agent to said V shape cutting portion.

8. A bending processing method of a composite panel according to claim 4, characterized by
mounting said composite panel in a condition in which said stationary table and said first bending table are arranged in a substantial horizontal condition.

9. A bending processing device comprising:
a stationary table for mounting a composite panel;
a first bending table for mounting said composite panel in the same height of said stationary table and for rotating in an upper and lower direction a side of said stationary table as a center;
a second bending table mounted on an upper face of said composite panel in an upper portion of said first bending table and for rotating in an upper and lower direction a side of said stationary table as a center;
a cutting machine for cutting a center core member of said composite panel and for moving in an axial direction of said first bending table; and
a coating device for coating an adhesion agent to any one of said center core member and a face sheet of said composite panel.
